(19) United States
(12) Patent Application Publication
(10) Pub. No.: US 2018/0051163 A1
(43) Pub. Date: Feb. 22, 2018

(54) RUBBER COMPOSITION FOR TIRE TREADS AND PNEUMATIC TIRE

(71) Applicant: THE YOKOHAMA RUBBER CO., LTD., MINATO-KU, TOKYO (JP)

(72) Inventors: Manabu KATO, HIRATSUKA CITY, KANAGAWA (JP); Ryota TAKAHASHI, HIRATSUKA CITY, KANAGAWA (JP); Takahiro OKAMATSU, HIRATSUKA CITY, KANAGAWA (JP); Yoshiaki KIRINO, HIRATSUKA CITY, KANAGAWA (JP)

(21) Appl. No.: 15/557,701

(22) PCT Filed: Mar. 18, 2016
(86) PCT No.: PCT/JP2016/058829

§ 371 Date: Sep. 12, 2017

(30) Foreign Application Priority Data
Mar. 19, 2015 (JP) 2015-056621

(51) Int. Cl. C08L 15/00; B60C 1/00; C08L 9/06

(52) U.S. Cl. CPC C08L 15/00; B60C 1/0016; C08L 2205/03; C08L 2205/025; C08L 9/06

(57) ABSTRACT

A rubber composition for tire treads contains an inorganic filler containing silica and a diene rubber containing a carboxy-modified polymer. The content of the inorganic filler is from 70 to 170 parts by mass per 100 parts by mass of the diene rubber. The content of the silica is from 70 to 160 parts by mass per 100 parts by mass of the diene rubber. The carboxy-modified polymer is obtained by modifying a styrene-butadiene rubber (A) with a nitrone compound (B) having a carboxy group, and the content of the carboxy-modified polymer in the diene rubber is from 10 to 100 mass %. The content of styrene units in the styrene-butadiene rubber (A) is not less than 36 mass %. The degree of modification of the carboxy-modified polymer is from 0.02 to 4.0 mol %.

### TECHNICAL FIELD

The present invention relates to a rubber composition for tire treads and a pneumatic tire.

### BACKGROUND ART

A pneumatic tire consists of various members such as a tire tread portion, a bead portion, a sidewall portion, for example, and each member constituting the pneumatic tire is formed using a rubber composition containing carbon black, a rubber component, or the like.

As such a rubber composition, Patent Document 1 discloses a rubber composition containing styrene-butadiene copolymer rubber, carbon black, N,N′-diphenyl-p-phenylenedinitrone (nitrone compound), and the like (see Example 2).

Incidentally, the pneumatic tire described above may be used not only in general vehicles, but may also be used in high-performance vehicles traveling on public roads, racing vehicles traveling on circuits, or the like.

As the rubber composition for tire treads used to form a tire used in such a racing vehicle (hereinafter also simply referred to as “racing tire” or “race tire”) or in a high-performance vehicle (hereinafter also simply referred to as “high-performance tire”), Patent Document 2 discloses a composition containing 10 parts by weight of a diene rubber containing a styrene-butadiene rubber or the like and 40 to 90 parts by weight of silica, and the like.

### CITATION LIST

### Patent Literature

Patent Document 1: JP-A-2007-70439

Patent Document 2: JP-A-2014-189698A

### SUMMARY OF INVENTION

### Technical Problem

Such a race tire or high-performance tire is required to have excellent steering stability when traveling at high speed or excellent tire property stability when traveling at high speeds for a long period of time than the pneumatic tire used for traveling in a general vehicle.

Of these requirements, an example of away to enhance the steering stability when traveling at high speed is to enhance the rubber hardness or storage modulus of the tire.

In addition, one way to enhance the tire property stability when traveling at high speeds for a long period of time is to enhance the wear resistance or breaking strength at high temperatures. When traveling at high speeds for a long period of time, the tire is maintained in a high-temperature state for a long period of time, so damage to the tire increases, thereby deteriorating the tire property stability.

Further, the race tire or the high-performance tire is required to have properties more precisely suited to various road surface conditions (dry road surfaces, wet road surfaces, or the like) than the pneumatic tire used for traveling in a general vehicle. For example, the race tire is required to have grip performance suited to a wet road surface (excellent wet grip performance) when the road surface is in a wet state (in the case of a wet road surface). In addition, the high-performance tire is required to have excellent wet grip performance from the viewpoint of further enhancing safety or the like.

In order to enhance such wet grip performance, as disclosed in Patent Document 2, the compounded amount of silica in the rubber composition may be increased, which also tends to enhance the fuel consumption performance (realization of low fuel consumption).

However, the present inventors investigated rubber compositions having large compounded amounts of silica as described in Patent Document 2, and found that although the wet grip performance and fuel consumption performance when formed into a tire are relatively good, there is a need for further improvement. In addition, the rubber hardness, storage modulus, breaking strength at high temperatures, and wear resistance could not yet be considered satisfactory.

In order to further enhance the performance of the rubber composition for tire treads having a high silica content as described in Patent Document 2, the present inventors investigated the use of a styrene-butadiene rubber modified with a nitrone compound as described in Patent Document 1 (N,N′-diphenyl-p-phenylenedinitrone).

However, it was found that the resulting rubber composition exhibited poor wet grip performance, fuel consumption performance, breaking strength at high temperatures, and wear resistance when formed into a tire. In addition, the rubber hardness may become low sometimes.

Therefore, an object of the present invention is to provide a rubber composition for tire treads having excellent steering stability (rubber hardness and storage modulus) when traveling at high speed, property stability (wear resistance and breaking strength at high temperatures) when traveling for a long period of time, wet grip performance, and fuel consumption performance when formed into a tire, and a pneumatic tire using the same.

### Solution to Problem

The present inventors have conducted intensive studies in an attempt to solve the above-mentioned problems and found as a result that using a carboxy-modified polymer obtained by modifying a styrene-butadiene rubber with a nitrone compound having a carboxy group yields a composition having excellent steering stability when traveling at high speed, property stability when traveling for a long period of time, wet grip performance, and fuel consumption performance when formed into a tire. This has led to the completion of the present invention.

In other words, the present inventors found that the above-mentioned problems can be solved by the following constitution.

[1]

A rubber composition for tire treads comprising an inorganic filler containing silica and a diene rubber containing a carboxy-modified polymer;

the content of the inorganic filler is from 70 to 170 parts by mass per 100 parts by mass of the diene rubber;

the content of the silica is from 70 to 160 parts by mass per 100 parts by mass of the diene rubber;

the carboxy-modified polymer is obtained by modifying a styrene-butadiene rubber (A) with a nitrone compound (B) having a carboxy group;

the content of the carboxy-modified polymer in the diene rubber is from 10 to 100 mass %;

the content of styrene units in the styrene-butadiene rubber (A) is not less than 36 mass %; and

a degree of modification of the carboxy-modified polymer is from 0.02 to 4.0 mol %; the degree of modification being defined as a proportion (mol %) of double bonds modified by the nitrone compound (B) having a carboxy group relative to all double bonds attributed to butadiene in the styrene-butadiene rubber (A).

[2]

The rubber composition for tire treads according to [1], wherein the nitrone compound (B) having a carboxy group is a compound selected from the group consisting of

N-phenyl-α-(4-carboxyphenyl)nitrone,
N-phenyl-α-(3-carboxyphenyl)nitrone,
N-phenyl-α-(2-carboxyphenyl)nitrone,
N-(4-carboxyphenyl)-α-phenylnitrone.
N-(3-carboxyphenyl)-α-phenylnitrone, and
N-(2-carboxyphenyl)-α-phenylnitrone.
[3]

The rubber composition for tire treads according to [1] or [2], further containing a cyclic polysulfide represented by the general formula (s) to be described later;

wherein the content of the cyclic polysulfide is from 0.2 to 5 parts by mass per 100 parts by mass of the diene rubber.

[4]

The rubber composition for tire treads according to any one of [1] to [3], wherein the amount of the nitrone compound (B) having a carboxy group used for modifying the styrene-butadiene rubber (A) is from 0.1 to 10 parts by mass per 100 parts by mass of the diene rubber.

[5]

A pneumatic tire comprising tire treads formed using the rubber composition for tire treads described in any one of [1] to [4].

### Advantageous Effects of Invention

As described below, the present invention is able to provide a rubber composition for tire treads having excellent steering stability when traveling at high speed, property stability when traveling for a long period of time, wet grip performance, and fuel consumption performance when formed into a tire, and a pneumatic tire obtained using the rubber composition.

### BRIEF DESCRIPTION OF DRAWINGS

FIG. 1 is a partial cross-sectional schematic view of a tire that illustrates one embodiment of the pneumatic tire of the present invention.

### DESCRIPTION OF EMBODIMENTS

The rubber composition for tire treads and the pneumatic tire of the present invention will be described below.

Note that, in the present invention, numerical ranges indicated using “from . . . to . . . ” include the former number as the lower limit value and the later number as the upper limit value.

### Rubber Composition for Tire Treads

The rubber composition for tire treads according to the present invention (hereinafter also simply referred to as “rubber composition”) contains an inorganic filler containing silica and a diene rubber containing a carboxy-modified polymer.

Here, the content of the inorganic filler is from 70 to 170 parts by mass per 100 parts by mass of the diene rubber. In addition, the content of the silica is from 70 to 160 parts by mass per 100 parts by mass of the diene rubber.

Further, the carboxy-modified polymer is obtained by modifying a styrene-butadiene rubber (A) with a nitrone compound (B) having a carboxy group, and the content of the carboxy-modified polymer in the diene rubber is from 10 to 100 mass %.

In addition, the content of styrene units in the styrene-butadiene rubber (A) is not less than 36 mass %. Further, the degree of modification of the carboxy-modified polymer is from 0.02 to 4.0 mol %.

Since the rubber composition of the present invention has such a constitution, it is possible to forma tire tread having excellent steering stability when traveling at high speed, property stability when traveling for a long period of time, wet grip performance, and fuel consumption performance.

The details of the reasons for this are not clear, but the following reason is presumed to be one cause thereof.

In other words, the rubber composition of the present invention contains a carboxy-modified polymer obtained by modifying a styrene-butadiene rubber (A) with a nitrone compound (B) having a carboxy group. Therefore, the carboxy groups at the nitrone modification sites in the carboxy-modified polymer are thought to interact with the silica in the rubber composition so as to increase the dispersibility of the silica. As a result, it is thought that the effect of enhancing the wet grip performance and fuel consumption performance (low rolling resistance) imparted by the silica increases.

Furthermore, it is conceived that, since the carboxy groups at the nitrone modification sites in the carboxy-modified polymer interact with the silica in the rubber composition, strong bonds are formed between the rubber component and the silica so that the crosslinking points increase, thereby increasing the crosslinking density, which results in the enhancement of the rubber hardness and makes it possible to achieve a high breaking strength even at high temperatures. In addition, it is presumed that the storage modulus and the wear resistance are also enhanced as a result of such an enhancement in the physical strength of the rubber.

The components that are contained and the components that may be contained in the rubber composition of the present invention will be described in detail hereinafter.

### Diene Rubber

The diene rubber contained in the rubber composition of the present invention contains a carboxy-modified polymer.

### Carboxy-Modified Polymer

The carboxy-modified polymer is obtained by modifying a styrene-butadiene rubber (A) with a nitrone compound (B) having a carboxy group.

The content of the carboxy-modified polymer in the diene rubber is from 10 to 100 mass %, preferably from 50 to 90 mass %, and more preferably from 60 to 80 mass %. When the content of the carboxy-modified polymer is within the range described above, the function of the carboxy-modified polymer is sufficiently exhibited.

On the other hand, when the content of the carboxy-modified polymer is less than 10 mass %, at least one performance among the rubber hardness, wet grip performance, fuel consumption performance, storage modulus, breaking strength at high temperatures, and wear resistance becomes insufficient.

### Styrene-Butadiene Rubber (A)

As described above, the carboxy-modified polymer is obtained by modifying a styrene-butadiene rubber (A).

Such a styrene-butadiene rubber (A) can be produced using a styrene monomer and a butadiene monomer.

The styrene monomer used for the production of a styrene-butadiene rubber (A) is not particularly limited, but examples thereof include styrene, α-methylstyrene, 2-methylstyrene, 3-methylstyrene, 4-methylstyrene, 2-ethylstyrene, 3-ethylstyrene, 4-ethylstyrene, 2,4-diisopropylstyrene, 2,4-dimethylstyrene, 4-t-butylstyrene, 5-t-butyl-2-methylstyrene, dimethylaminomethylstyrene, and dimethylaminoethylstyrene. Among these, styrene, α-methylstyrene, and 4-methylstyrene are preferred, and styrene is more preferred. Such a styrene monomer may be used alone, or a combination of two or more types may be used.

Examples of the butadiene monomer used for the production of the styrene-butadiene rubber (A) is not particularly limited, but examples thereof include 1,3-butadiene, isoprene(2-methyl-1,3-butadiene), 2,3-dimethyl-1,3-butadiene, and 2-chloro-1,3-butadiene. Among these, 1,3-butadiene or isoprene is preferred, and 1, 3-butadiene is more preferred. Such a butadiene monomer may be used alone, or a combination of two or more types may be used.

The method (polymerization method) for producing the styrene-butadiene rubber (A) is not particularly limited, but examples thereof include solution polymerization or emulsion polymerization. Either a solution-polymerized styrene-butadiene rubber or an emulsion-polymerized styrene-butadiene rubber may be used as the styrene-butadiene rubber (A), but the solution-polymerized styrene-butadiene rubber is preferably used from the viewpoint of further enhancing the steering stability and the like.

The content of styrene units in the styrene-butadiene rubber (A) is not less than 36 mass %, preferably from 36 to 50 mass %, and more preferably from 36 to 40 mass %. When the content of styrene units is within the range described above, the rubber hardness of the tire or the breaking strength at high temperatures is enhanced. On the other hand, when the content of styrene units is less than 36 mass %, the rubber hardness of the tire or the breaking strength at high temperatures is diminished.

Note that in the present invention, the content of styrene units in the styrene-butadiene rubber indicates the proportion (mass %) of the styrene monomer units in the styrene-butadiene rubber.

From the viewpoint of ease of handling, the weight average molecular weight (Mw) of styrene-butadiene rubber (A) is preferably from 100000 to 1800000 and more preferably from 300000 to 1500000. In the present specification, the weight average molecular weight (Mw) is measured by gel permeation chromatography (GPC) based on calibration with polystyrene standards using tetrahydrofuran as a solvent.

### Nitrone Compound (B) Having a Carboxy Group

As described above, the carboxy-modified polymer of the present invention is modified using a nitrone compound (B) having a carboxy group (hereinafter, also simply referred to as “carboxynitrone” or “carboxynitrone (B)”).

The carboxynitrone is not particularly limited as long as it is a nitrone that has at least one carboxy group (—COOH). The nitrone herein refers to a compound having a nitrone group represented by Formula (1) below.

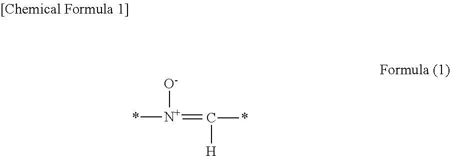

In Formula (1), * indicates a bonding position.

The carboxynitrone is preferably a compound represented by general formula (2) below.

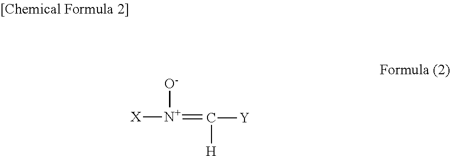

In general formula (2), X and Y each independently represent an aliphatic hydrocarbon group, an aromatic hydrocarbon group, or an aromatic heterocycle group that may have a substituent. However, at least one of X or Y has a carboxy group as a substituent.

Examples of the aliphatic hydrocarbon group represented by X or Y include alkyl groups, cycloalkyl groups, alkenyl groups, and the like. Examples of the alkyl group include a methyl group, ethyl group, n-propyl group, isopropyl group, n-butyl group, isobutyl group, sec-butyl group, tert-butyl group, n-pentyl group, isopentyl group, neopentyl group, tert-pentyl group, 1-methylbutyl group, 2-methylbutyl group, 1,2-dimethylpropyl group, n-hexyl group, n-heptyl group, n-octyl group, and the like. Among these, alkyl groups having from 1 to 18 carbons are preferable, and alkyl groups having from 1 to 6 carbons are more preferable. Examples of the cycloalkyl group include a cyclopropyl group, cyclobutyl group, cyclopentyl group, cyclohexyl group, and the like. Among these, cycloalkyl groups having from 3 to 10 carbons are preferable, and cycloalkyl groups having from 3 to 6 carbons are more preferable. Examples of the alkenyl group include a vinyl group, 1-propenyl group, allyl group, isopropenyl group, 1-butenyl group, 2-butenyl group, and the like. Among these, alkenyl groups having from 2 to 18 carbons are preferable, and alkenyl groups having from 2 to 6 carbons are more preferable.

Examples of the aromatic hydrocarbon group represented by X or Y include aryl groups, aralkyl groups, and the like.

Examples of the aryl group include a phenyl group, naphthyl group, anthryl group, phenanthryl group, biphenyl group, and the like. Among these, aryl groups having from 6 to 14 carbons are preferable, aryl groups having from 6 to 10 carbons are more preferable, and a phenyl group and a naphthyl group are even more preferable.

Examples of the aralkyl group include a benzyl group, phenethyl group, phenylpropyl group, and the like. Among these, aralkyl groups having from 7 to 13 carbons are preferable, aralkyl groups having from 7 to 11 carbons are more preferable, and a benzyl group is even more preferable.

Examples of the aromatic heterocyclic group represented by X or Y include pyrrolyl groups, furyl groups, thienyl groups, pyrazolyl groups, imadazolyl groups (imadazole groups), oxazolyl groups, isooxazolyl groups, thiazolyl groups, isothiazolyl groups, pyridyl groups (pyridine groups), furan groups, thiophene groups, pyridazinyl groups, pyrimidinyl groups, pyradinyl groups, and the like. Among these, pyridyl groups are preferable.

The groups represented by X and Y may have substituents other than carboxy groups (hereinafter, also referred to as “other substituents”) as long as at least one of them has a carboxy group as a substituent, as described above.

The other substituents that may be included in the group represented by X or Y are not particularly limited, and examples thereof include alkyl groups having from 1 to 4 carbons, hydroxy groups, amino groups, nitro groups, sulfonyl groups, alkoxy groups, halogen atoms, and the like.

Note that examples of the aromatic hydrocarbon group having such a substituent include aryl groups having a substituent, such as a tolyl group and xylyl group; and aralkyl groups having a substituent, such as a methylbenzyl group, ethylbenzyl group, and methylphenethyl group; and the like.

The compound represented by general formula (2) is preferably a compound represented by the following general formula (b).

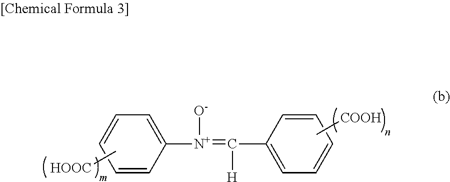

In general formula (b), m and n each independently represent an integer of 0 to 5, and the sum of m and n is 1 or greater.

The integer represented by m is preferably an integer of 0 to 2, and more preferably an integer of 0 or 1, because solubility to a solvent during carboxynitrone synthesis will be better and thus synthesis will be easier.

The integer represented by n is preferably an integer of 0 to 2, and more preferably an integer of 0 or 1, because solubility to a solvent during carboxynitrone synthesis will be better and thus synthesis will be easier.

Furthermore, the sum of m and n (m+n) is preferably from 1 to 4, and more preferably 1 or 2.

The compound is not particularly limited to a carboxynitrone such as that represented by general formula (b) but is preferably a compound selected from the group consisting of N-phenyl-α-(4-carboxyphenyl)nitrone represented by Formula (b1) below,

N-phenyl-α-(3-carboxyphenyl)nitrone represented by Formula (b2) below, N-phenyl-α-(2-carboxyphenyl)nitrone represented by Formula (b3) below, N-(4-carboxyphenyl)-α-phenylnitrone represented by Formula (b4) below, N-(3-carboxyphenyl)-α-phenylnitrone represented by Formula (b5) below, and N-(2-carboxyphenyl)-α-phenylnitrone represented by Formula (b6) below.

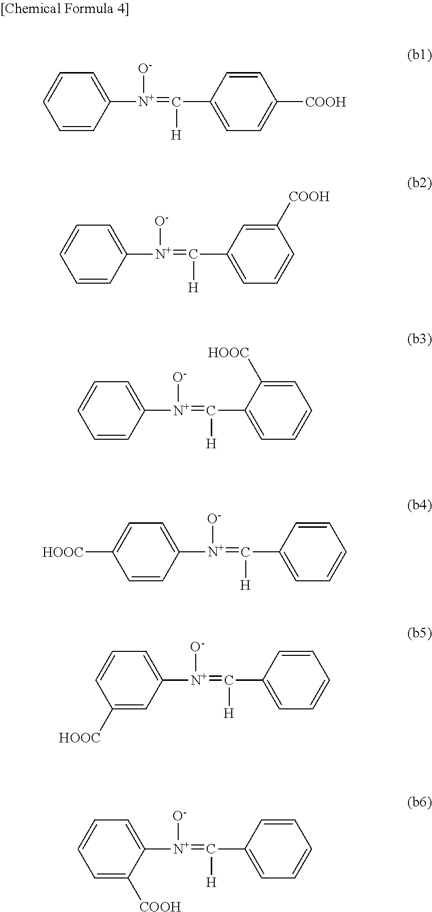 [SMILES: O=C(O)c1ccc(/C=[N+](\[O-])c2ccccc2)cc1 ; O=C(O)c1cccc(/C=[N+](\[O-])c2ccccc2)c1 ; O=C(O)c1ccccc1/C=[N+](\[O-])c1ccccc1 ; O=C(O)c1ccc(/[N+]([O-])=C/c2ccccc2)cc1 ; O=C(O)c1cccc(/[N+]([O-])=C/c2ccccc2)c1 ; O=C(O)c1ccccc1/[N+]([O-])=C/c1ccccc1]

The method of synthesizing the carboxynitrone is not particularly limited, and conventionally known methods can be used. For example, a compound (carboxynitrone) having a carboxy group and a nitrone group can be obtained by stirring a compound having a hydroxyamino group (—NHOH) and a compound having an aldehyde group (—CHO) and a carboxy group at a molar ratio of hydroxyamino group to aldehyde group (—NHOH/—CHO) of 1.0 to 1.5 in the presence of an organic solvent (for example methanol, ethanol, tetrahydrofuran, and the like) at room temperature for 1 to 24 hours to allow the both groups to react.

### Method for Producing Carboxy-Modified Polymer

As described above, the carboxy-modified polymer of the present invention is obtained by modifying a styrene-butadiene rubber (A) with a nitrone compound (B) having a carboxy group.

The reaction mechanism at the time of the production of the carboxy-modified polymer is to react the carboxy-modified polymer (B) with the double bonds of the styrene-butadiene rubber (A). The method for producing the carboxy-modified polymer (carboxynitrone-modified SBR) is not particularly limited, but examples thereof include a method in which the styrene-butadiene rubber (A) and the carboxynitrone (B) are blended together for 1 to 30 minutes at 100 to 200° C.

In the method, a cycloaddition reaction occurs between the double bond of the butadiene contained in the styrene-butadiene rubber (A) and the nitrone group in the carboxynitrone (B), forming a five-membered ring as illustrated in Formula (4-1) and Formula (4-2) below. Note that formula (4-1) below represents a reaction between a 1,4 bond and a nitrone group, and formula (4-2) below represents a reaction between a 1,2-vinyl bond and a nitrone group. Formulas (4-1) and (4-2) illustrate the reactions for the case where the butadiene is 1, 3-butadiene, but the same reaction leads to a formation of a five-membered ring even in the case where the butadiene is other than 1,3-butadiene.

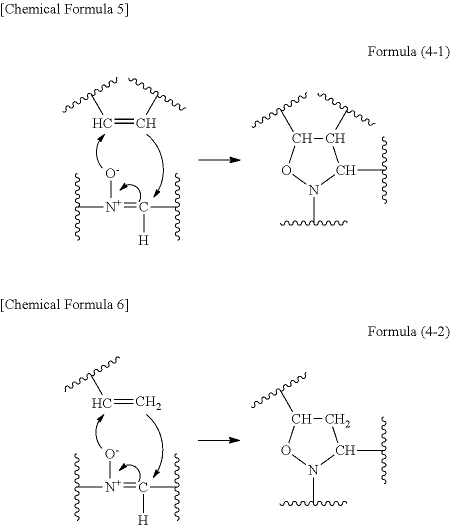

The amount of the carboxynitrone (B) (hereinafter also referred to as “converted CPN amount”) used to modify the styrene-butadiene rubber (A) so as to synthesize the carboxy-modified polymer is preferably from 0.1 to 10 parts by mass and more preferably from 0.3 to 3 parts by mass per 100 parts by mass of the diene rubber. If the converted CPN amount is within the range described above, the wet grip performance or fuel consumption performance tends to be further enhanced.

For example, if 35 parts by mass of the carboxy-modified polymer is included in 100 parts by mass of the diene rubber and the carboxy-modified polymer is obtained via the reaction between 100 parts by mass of SBR and 1 part by mass of carboxynitrone, 0.35 parts by mass (=35×(1/101)) of the carboxynitrone (B) is used for the synthesis of the carboxy-modified polymer out of 35 parts by mass of the carboxy-modified polymer, so the converted CPN amount is 0.35 parts by mass.

In the synthesis of the carboxy-modified polymer, the charged amount (added amount) of the carboxynitrone (B) is not particularly limited, but it is preferably from 0.1 to 20 parts by mass and more preferably from 1 to 5 parts by mass per 100 parts by mass of the styrene-butadiene rubber (A).

### Degree of Modification

The degree of modification of the carboxy-modified polymer is from 0.02 to 4.0 mol % and more preferably from 0.10 to 2.0 mol %. In addition, the lower limit of the degree of modification is preferably not less than 0.20 mol %.

Here, the “degree of modification” refers to the proportion (mol %) of the double bonds modified with the carboxynitrone (B) relative to all the double bonds attributed to butadiene (butadiene unit) in the styrene-butadiene rubber (A). For example, if the butadiene is 1,3-butadiene, the “degree of modification” refers to the proportion (mol %) of the structure represented by Formula (4-1) or Formula (4-2) above formed by modification with carboxynitrone. The degree of modification, for example, can be found by NMR measurements of the SBRs before and after the modification.

Note that in this specification, the carboxy-modified polymer with the degree of modification of 100 mol % also falls under the category of a diene rubber.

### Other Diene Rubber

The diene rubber may contain a rubber component other than the carboxy-modified polymer (hereinafter also referred to as “other diene rubber”). The other diene rubber is not particularly limited, but examples thereof include a natural rubber (NR), isoprene rubber (IR), butadiene rubber (BR), aromatic vinyl-conjugated diene copolymer rubber (e.g., unmodified SBR (styrene-butadiene rubber), SBR modified by a compound other than the nitrone compound (B) having a carboxy group), acrylonitrile-butadiene copolymer rubber (NBR), butyl rubber (IIR), halogenated butyl rubber (Br—IIR, Cl—IIR), chloroprene rubber (CR), and the like. Among these, an unmodified SBR is preferably used. Preferable modes of such an unmodified SBR are the same as those of the styrene-butadiene rubber (A) described above.

### Inorganic Filler

The rubber composition of the present invention contains an inorganic filler. The inorganic filler contained in the rubber composition of the present invention contains silica and an inorganic filler other than silica (hereinafter also referred to as “other inorganic filler”).

Examples of such other inorganic fillers include carbon black, calcium carbonate, clay, talc, and the like, and carbon black is preferably used.

The content of the inorganic filler is from 70 to 170 parts by mass, preferably from 80 to 130 parts by mass, and more preferably from 90 to 120 parts by mass per 100 parts by mass of the diene rubber. When the content of the inorganic filler is within the range described above, the wet grip performance, fuel consumption performance, rubber hardness, breaking strength at high temperatures, and the like can be enhanced. On the other hand, when the content of the inorganic filler is below the lower limit, the wet grip performance or fuel consumption performance is deteriorated, whereas when the content of the inorganic filler exceeds the upper limit, the rubber hardness or breaking strength at high temperatures is deteriorated.

### Silica

Specific examples of the silica include wet silica (hydrous silicic acid), dry silica (silicic anhydride), calcium silicate, aluminum silicate, and the like. One type of these may be used alone, or two or more types of these may be used in combination.

The content of the silica is from 70 to 160 parts by mass, preferably from 80 to 160 parts by mass, and more preferably from 90 to 160 parts by mass per 100 parts by mass of the diene rubber. When the content of the silica is within the range described above, the wet grip performance and fuel economy consumption can be enhanced. On the other hand, when the content of the silica is below the lower limit, the wet grip performance or fuel consumption performance is deteriorated, whereas when the content of the silica exceeds the upper limit, the rubber hardness or breaking strength at high temperatures is deteriorated.

The cetyltrimethylammonium bromide (CTAB) adsorption specific area of the silica is preferably from 50 to 230 m²/g and more preferably from 100 to 185 m²/g.

Note that the CTAB adsorption specific surface area is an alternative characteristic of the surface area of the silica that can be utilized for adsorption to the silane coupling agent. The CTAB adsorption specific surface area is a value determined by measuring the amount of CTAB adsorption to the silica surface in accordance with JIS K6217-3:2001 “Part 3: How to Determine Specific Surface Area—CTAB Adsorption Method”.

### Carbon Black

The rubber composition of the present invention preferably contains carbon black as an inorganic filler.

The content of the carbon black is preferably from 10 to 100 parts by mass, more preferably from 10 to 80 parts by mass, and even more preferably from 10 to 60 parts by mass per 100 parts by mass of the diene rubber. When the content of the carbon black is within the range described above, it is possible to achieve a balance between the rubber hardness or breaking strength at high temperatures and the wet grip performance or fuel consumption performance.

The nitrogen adsorption specific surface area (N₂SA) of the carbon black is not particularly limited, but is preferably from 100 to 200 [/g], and more preferably from 120 to 195 [m²/g].

Note that the nitrogen adsorption specific surface area (N₂SA) is a value of the amount of nitrogen adsorbed to the surface of carbon black, measured in accordance with JIS K6217-2:2001 (Part 2: Determination of specific surface area—Nitrogen adsorption methods—Single-point procedures).

### Cyclic Polysulfide

The rubber composition of the present invention preferably contains a cyclic polysulfide as a vulcanizing agent. The cyclic polysulfide represented by general formula (s) below is preferably used as a cyclic polysulfide from the viewpoint of further enhancing the rubber hardness or the breaking strength at high temperatures.

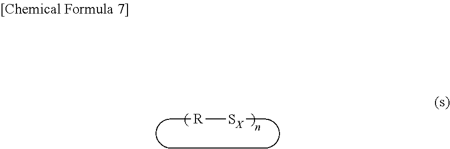

In general formula (s) above, R is a substituted or unsubstituted alkylene group having from 4 to 8 carbon atoms, a substituted or unsubstituted oxyalkylene group having from 4 to 8 carbon atoms (“—R₁—O—”, where R₁ is an alkylene group having from 4 to 8 carbon atoms), or —R₂—O—R₃— (where R₂ and R₃ are each independently an alkylene group having from 1 to 7 carbon atoms). Here, x is from 3 to 5 on average. In addition, n is an integer of 1 to 5.

In general formula (s), the number of carbon atoms of R is from 4 to 8 and is preferably from 4 to 7.

In addition, examples of substituents in R in general formula (s) above include a phenyl group, benzyl group, methyl group, epoxy group, isocyanate group, vinyl group, silyl group, and the like.

Note that S in general formula (s) is sulfur.

Here, x is from 3 to 5 on average and is preferably from 3.5 to 4.5 on average.

In addition, n is an integer of 1 to 5 and is preferably an integer of 1 to 4.

The cyclic polysulfide represented by general formula (s) can be produced by ordinary methods, an example of which is the production method described in JP-A-2007-92086.

### Silane Coupling Agent

The rubber composition of the present invention preferably contains a silane coupling agent because it improves the reinforcing performance of the tire.

When the silane coupling agent is used, the content thereof is preferably from 2 to 16 parts by mass and more preferably from 4 to 10 parts by mass per 100 parts by mass of the silica.

Specific examples of the silane coupling agent include bis(3-triethoxysilylpropyl)tetrasulfide, bis(3-triethoxysilylpropyl)trisulfide, bis(3-triethoxysilylpropyl)disulfide, bis(2-triethoxysilylethyl)tetrasulfide, bis(3-trimethoxysilylpropyl)tetrasulfide, bis(2-trimethoxysilylethyl) tetrasulfide, 3-mercaptopropyltrimethoxysilane, 3-mercaptopropyltriethoxysilane, 2-mercaptoethyltrimethoxysilane, 2-mercaptoethyltriethoxysilane, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilylethyl-N,N-dimethylthiocarbamoyl tetrasulfide, 3-trimethoxysilylpropyl benzothiazole tetrasulfide, 3-triethoxysilylpropyl benzothiazole tetrasulfide, 3-triethoxysilylpropyl methacrylate monosulfide, 3-trimethoxysilylpropyl methacrylate monosulfide, bis(3-diethoxymethylsilylpropyl)tetrasulfide, 3-mercaptopropyldimethoxymethylsilane, dimethoxymethylsilylpropyl-N,N-dimethylthiocarbamoyl tetrasulfide, dimethoxymethylsilylpropyl benzothiazole tetrasulfide, and the like. These may be used alone, or two or more of them may be used in combination.

Of these, it is preferable to use bis-(3-triethoxysilylpropyl)tetrasulfide and/or bis-(3-triethoxysilylpropyl)disulfide from the viewpoint of a reinforcing property enhancing effect. Specific examples thereof include Si69 [bis(3-triethoxysilylpropyl)tetrasulfide, manufactured by Evonik Degussa], Si75 [bis(3-triethoxysilylpropyl)disulfide, manufactured by Evonik Degussa], and the like.

### Optional Components

The rubber composition of the present invention may contain a terpene resin. Among terpene resins, an aromatic modified terpene resin is preferably used.

When the rubber composition contains an aromatic modified terpene resin, the content thereof is preferably from 2 to 20 parts by mass and more preferably from 4 to 18 parts by mass per 100 parts by mass of the diene rubber.

The aromatic modified terpene resin is obtained by polymerizing a terpene and an aromatic compound. Examples of the terpene include α-pinene, β-pinene, dipentene, limonene, and the like. Examples of the aromatic compound include styrene, α-methylstyrene, vinyl toluene, indene, and the like. Among these, styrene modified terpene resins are preferable as the aromatic modified terpene resin.

The rubber composition of the present invention may further contain additives as necessary within a scope that does not inhibit the effect or purpose thereof.

Examples of additives include various additives typically used in rubber compositions, zinc oxide (zinc white), stearic acid, adhesive resins, peptizing agents, antiaging agents, waxes, processing aids, aroma oils, liquid polymers, terpene resins other than aromatic terpene resins, thermosetting resins, vulcanizing agents other than cyclic polysulfides (for example, sulfur), vulcanization accelerators, and the like.

Method for producing Rubber Composition for Tire Treads

The method for producing the rubber composition of the present invention is not particularly limited, and specific examples thereof include a method whereby each of the above-mentioned components is kneaded using a known method and device (for example, Banbury mixer, kneader, roller, and the like). When the rubber composition of the present invention contains a sulfur or a vulcanization accelerator, the components other than the sulfur and the vulcanization accelerator are preferably blended first at a high temperature (preferably from 80 to 140° C.) and then cooled before the sulfur or the vulcanization accelerator is blended.

In addition, the rubber composition of the present invention can be vulcanized or crosslinked under conventional, publicly known vulcanizing or crosslinking conditions.

### Application

The rubber composition of the present invention is used in production of pneumatic tires. Of these, the rubber composition is suitably used in tire treads of pneumatic tires (preferably pneumatic tires for racing and pneumatic tires for high-performance vehicles which travel on public roads).

### Pneumatic Tire

The pneumatic tire of the present invention is a pneumatic tire that uses the above rubber composition for tire treads of the present invention.

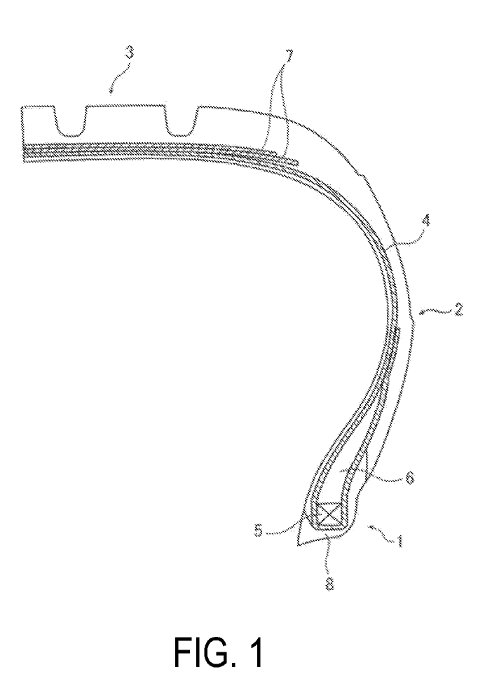

FIG. 1 is a partial cross-sectional schematic view of a tire that represents one embodiment of the pneumatic tire of the present invention, but the pneumatic tire of the present invention is not limited to the embodiment illustrated in FIG. 1.

In FIG. 1, reference numeral 1 denotes a bead portion, reference numeral 2 denotes a sidewall portion, and reference numeral 3 denotes a tire tread portion.

A carcass layer 4, in which a fiber cord is embedded, is mounted between a left-right pair of the bead portions 1, and ends of the carcass layer 4 are wound by being folded around bead cores 5 and bead fillers 6 from an inner side to an outer side of the tire.

In the tire tread portion 3, a belt layer 7 is provided along the entire periphery of the tire on the outer side of the carcass layer 4.

Rim cushions 8 are provided in parts of the bead portions 1 that are in contact with a rim.

Note that the tire tread portion 3 is formed from the above rubber composition of the present invention.

The pneumatic tire of the present invention can be produced, for example, in accordance with a conventionally known method. In addition to ordinary air or air with an adjusted oxygen partial pressure, inert gases such as nitrogen, argon, and helium can be used as the gas with which the tire is filled.

Since the pneumatic tire of the present invention has excellent steering stability (rubber hardness and storage modulus) when traveling at high speed and stability (wear resistance and breaking strength at high temperatures) when traveling for a long period of time, the pneumatic tire is suitably used for racing tires and high-performance tires. In particular, the pneumatic tire is suitably used on wet road surfaces.

### Examples

Hereinafter, the present invention will be further described in detail with reference to examples. However, the present invention is not limited to these examples.

### Synthesis of Carboxynitrone

In a 2 L eggplant-shaped flask, methanol heated to 40° C. (900 mL) was placed, and then terephthalaldehydic acid represented by Formula (b-1) below (30.0 g) was added and dissolved. To this solution, a solution in which phenylhydroxylamine represented by Formula (a-1) below (21.8 g) was dissolved in methanol (100 mL) was added and stirred at room temperature for 19 hours. After the completion of stirring, a nitrone compound (carboxynitrone) represented by Formula (c-1) below was obtained by recrystallization from methanol (41.7 g). The yield was 86%.

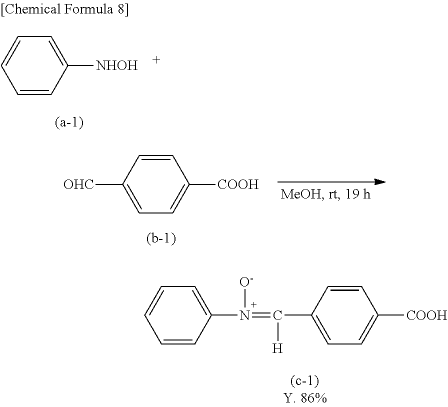

### Synthesis of Diphenylnitrone

In a 300 mL egg-plant shaped flask, benzaldehyde represented by Formula (b-2) below (42.45 g) and ethanol (10 mL) were placed, and then a solution in which phenylhydroxylamine represented by Formula (a-1) below (43.65 g) was dissolved in ethanol (70 mL) was added and stirred at room temperature for 22 hours. After the completion of stirring, diphenylnitrone (65.40 g) represented by Formula (c-2) below was obtained as a white crystal by recrystallization from ethanol. The yield was 83%.

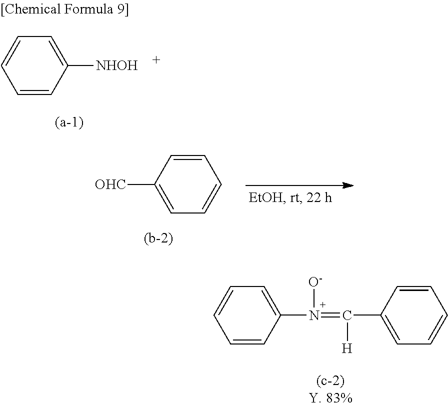

### Synthesis of Carboxynitrone-Modified SBR (Modified SBR 1)

SBR (“Tufdene E581”, manufactured by Asahi Kasei Chemicals Corporation) was loaded into a Banbury mixer at 120° C. and kneaded for 2 minutes. Then, 1 part by mass of the carboxynitrone synthesized as described above was added per 100 parts by mass of SBR and mixed at 160° C. for 5 minutes to modify the SBR with the carboxynitrone. The carboxynitrone-modified SBR obtained thus is referred to as the modified SBR 1.

Note that the SBR that was used (“Tufdene E581”, manufactured by Asahi Kasei Chemicals Corporation) corresponds to “S-SBR 2” described below, and the styrene unit content (styrene amount) is 37 mass %.

When NMR analysis was performed for the obtained modified SBR 1 to determine the degree of modification, the degree of modification of the modified BR 1 was 0.21 mol %. Specifically, the degree of modification was determined as follows. In other words, the degree of modification was determined by ¹H-NMR (CDCl₃, 400 MHz, TMS) by measuring peak areas at around 8.08 ppm (attributed to two protons adjacent to the carboxy group) before and after the modification of SBRs using CDCl₃ as a solvent. Note that the ¹H-NMR analysis of the modified SBR 1 was performed by using a sample obtained by dissolving the modified SBR 1 in toluene, performing purification by methanol precipitation twice, and then drying under reduced pressure.

### Synthesis of Diphenylnitrone-Modified SBR (Modified SBR 2)

SBR (“Tufdene E581”, manufactured by Asahi Kasei Chemicals Corporation) was loaded into a Banbury mixer at 120° C. and kneaded for 2 minutes. Then, 1 part by mass of the diphenylnitrone synthesized as described above was added per 100 parts by mass of SBR and mixed at 160° C. for 5 minutes to modify the SBR with the diphenylnitrone. The obtained diphenylnitrone-modified SBR is referred to as the modified SBR 2.

Note that the SBR that was used (“Tufdene E581”, manufactured by Asahi Kasei Chemicals Corporation) corresponds to “S-SBR 2” described below, and the styrene unit content (styrene amount) is 37 mass %.

When NMR analysis was performed for the obtained modified SBR 2 to determine the degree of modification, the degree of modification of the modified SBR 2 was 0.23 mol %. The method of determining the degree of modification is as described above.

### Preparation of Rubber Composition for Tire Treads

The components shown in Table 1 below were compounded in the proportions (parts by mass) shown in Table 1 below.

Specifically, the components shown in Table 1 below except for the sulfur and the vulcanization accelerator were first mixed in a Banbury mixer with a temperature of 80° C. for 5 minutes. Thereafter, a roll was used to mix the sulfur and the vulcanization accelerator to obtain each rubber composition for tire treads (hereinafter “rubber composition for tire treads” is also simply referred to as “rubber composition”).

### Preparation of Vulcanized Rubber Sheet

A vulcanized rubber sheet was prepared by press-vulcanizing each of the obtained (unvulcanized) rubber compositions for 15 minutes at 160° C. in a mold (15 cm×15 cm×0.2 cm).

### Evaluation of Rubber Hardness

In accordance with JIS K6253, a type A durometer was used to measure the rubber hardness of each obtained vulcanized rubber sheet at a temperature of 20° C. The results are shown in Table 1 (rubber hardness). The results are shown as index values, with the value of Comparative Example 1 expressed as 100. Greater values indicate that the rubber composition has superior rubber hardness when formed into a tire.

### Wet Grip Performance Evaluation

The loss tangent at a temperature of 0° C., tan δ (0° C.) was measured for each obtained vulcanized rubber sheet using a viscoelastic spectrometer (manufactured by Toyo Seiki Seisaku-sho, Ltd.) under the following conditions: 10% initial distortion, ±2% amplitude, and 20 Hz frequency. The results are shown in Table 1 (wet grip performance). The results are shown as index values, with the tan δ (60° C.) of Comparative Example 1 expressed as 100. Greater values indicate that the rubber composition has superior wet grip performance when formed into a tire.

### Evaluation of Fuel Consumption Performance

The value of tan δ (60° C.) was measured in the same manner as in the evaluation of wet grip performance with the exception that the evaluation was performed at a temperature of 60° C. The results are shown in Table 1 (fuel consumption performance). The results are shown as the reciprocal of the value of tan δ (0° C.), with the value of Comparative Example 1 expressed as an index of 100. Greater values indicate that the rubber composition has superior fuel consumption performance (low fuel consumption) when formed into a tire.

### Evaluation of Storage Modulus

The storage modulus (E′) at a temperature of 60° C. was measured for each obtained vulcanized rubber sheet using a viscoelastic spectrometer (manufactured by Toyo Seiki Seisaku-sho, Ltd.) under the following conditions: 10% initial distortion, ±2% amplitude, and 20 Hz frequency. The results are shown in Table 1. The results are shown as index values, with the storage modulus (E′) of Comparative Example 1 expressed as 100. Greater values indicated that the rubber composition has superior steering stability when formed into a tire.

### Evaluation of Breaking Strength

JIS #3 dumbbell test pieces (thickness: 2 mm) were punched out from the obtained vulcanized rubber sheets in accordance with JIS K6251, and the breaking strength (stress at the time of breakage) was measured at 100° C. at a tensile test speed of 500 mm/minute. The results are shown in Table 1 (breaking strength). The results are shown as index values, with the breaking strength of Comparative Example 1 expressed as 100. Greater values indicate that the rubber composition has superior breaking strength when formed into a tire.

### Evaluation of Wear Resistance

For the obtained vulcanized rubber sheets, the amount of wear was measured using the Pico Abrasion Tester in accordance with ASTM-D2228. The results are shown in Table 1 (wear resistance). The results are expressed as the reciprocal of the amount of wear, with the value of Comparative Example 1 expressed as an index value of 100. Greater values indicate (that is, smaller amount of wear) that the rubber composition has superior wear resistance when formed into a tire.

In Table 1, converted nitrone amount indicates the amount in terms of parts by mass of the nitrone compound used in the synthesis of the modified polymer (modified SBR 1 or modified SBR 2) relative to 100 parts by mass of the diene rubber. Note that when carboxynitrone is used for modification, the converted nitrone amount is synonymous with the converted CPN amount described above.

In addition, the degree of modification represents the degree of modification of the modified polymer (modified SBR 1 or modified SBR 2) described above. The modification efficiency expresses the proportion of the nitrone compound used in the reaction relative to the charged amount of the nitrone compound.

In addition, in Table 1, the numerical values for S-SBR 1, S-SBR 2, modified SBR 1, and modified SBR 2 represent the content (parts by mass) including the oil content, and the numerical values in parentheses indicate the content (parts by mass) of the rubber components.

TABLE 1

| | | Comparative | | Comparative | | Comparative | | | | | | | |
|---|---|---|---|---|---|---|---|---|---|---|---|---|---|
| | | Example 1 | | Example 2 | | Example 3 | | Example 1 | | Example 2 | | Example 3 | |
| Diene | S-SBR1 | 50.00 | (36.36) | 50.00 | (36.36) | 50.00 | (36.36) | 50.00 | (36.36) | 50.00 | (36.36) | 50.00 | (36.36) |
| rubber | S-SBR2 | 87.5 | (63.64) | 43.75 | (31.82) | | | 43.75 | (31.82) | | | 73.40 | (53.37) |
| | Modified SBR 1 | | | | | | | 43.75 | (31.82) | 87.5 | (63.64) | 14.10 | (10.27) |
| | (Carboxynitrone- | | | | | | | | | | | | |
| | modified SBR) | | | | | | | | | | | | |
| | Modified SBR 2 | | | 43.75 | (31.82) | 87.5 | (63.64) | | | | | | |
| | (Diphenylnitrone- | | | | | | | | | | | | |
| | modified SBR) | | | | | | | | | | | | |

| Carbon black | | 10.00 | 10.00 | 10.00 | 10.00 | 10.00 | 10.00 |
|---|---|---|---|---|---|---|---|
| Silica | | 130.00 | 130.00 | 130.00 | 130.00 | 130.00 | 130.00 |
| Silane coupling agent | | 10.00 | 10.00 | 10.00 | 10.00 | 10.00 | 10.00 |
| Other | Stearic acid | 2.00 | 2.00 | 2.00 | 2.00 | 2.00 | 2.00 |
| components | Terpene resin | 10.00 | 10.00 | 10.00 | 10.00 | 10.00 | 10.00 |
| | Oil | 15.00 | 15.00 | 15.00 | 15.00 | 15.00 | 15.00 |
| | Zinc white | 3.00 | 3.00 | 3.00 | 3.00 | 3.00 | 3.00 |
| | Sulfur | 1.50 | 1.50 | 1.50 | 1.50 | 1.50 | 1.50 |
| | Cyclic polysulfide | 0.50 | 0.50 | 0.50 | 0.50 | 0.50 | 0.50 |
| | Vulcanization accelerator | 1.50 | 1.50 | 1.50 | 1.50 | 1.50 | 1.50 |
| Modified | Converted nitrone amount | | 0.31 | 0.63 | 0.31 | 0.63 | 0.10 |
| polymer | Modification efficiency | | 82% | 82% | 76% | 76% | 76% |
| properties | Degree of modification | | 0.23 | 0.23 | 0.21 | 0.21 | 0.21 |
| | of modified polymer | | | | | | |
| | (mol %) | | | | | | |
| Evaluation | Rubber hardness | 100 | 102 | 99 | 103 | 102 | 101 |
| Results | (at 20° C.) | | | | | | |
| | Wet grip performance | 100 | 98 | 97 | 101 | 104 | 101 |
| | (tan δ | | | | | | |
| | (0° C.)) | | | | | | |
| | Fuel consumption | 100 | 98 | 96 | 112 | 119 | 106 |
| | performance | | | | | | |
| | (tan δ (60° C.)) | | | | | | |
| | Storage modulus (E′ | 100 | 103 | 105 | 109 | 105 | 103 |
| | (60° C.)) | | | | | | |
| | Breaking strength | 100 | 96 | 95 | 109 | 107 | 106 |
| | (100° C.) | | | | | | |
| | Wear resistance | 100 | 89 | 99 | 106 | 110 | 103 |

The details of each component shown in Table 1 above are as follows.
S-SBR 1: Solution-polymerized styrene-butadiene rubber “Tufdene E680”, manufactured by Asahi Kasei Chemicals Corporation; an oil-extended product having a styrene content of 36 wt. %; a weight average molecular weight (Mw) of 1470000; a Tg of −13° C.; and an oil component of 37.5 parts by mass per 100 parts by mass of rubber component
S-SBR 2: Solution-polymerized styrene-butadiene rubber “Tufdene E581”, manufactured by Asahi Kasei Chemicals Corporation; an oil-extended product having a styrene content of 37 wt. %; a weight average molecular weight (Mw) of 1260000; a Tg of −27° C.; and an oil component of 37.5 parts by mass per 100 parts by mass of rubber component
Modified SBR 1: Modified SBR 1 synthesized as described above (carboxynitrone-modified SBR); an oil extended product having an oil component of 37.5 parts by mass per 100 parts by mass of rubber component
Modified SBR 2: Modified SBR 2 synthesized as described above (diphenylnitrone-modified SBR); an oil extended product having an oil component of 37.5 parts by mass per 100 parts by mass of rubber component
Carbon black: “SEAST 9M” manufactured by Tokai Carbon Co., Ltd.; nitrogen specific surface area: 142 m²/g
Silica: “Zeosil 1165MP” (CTAB specific surface area: 159 m²/g; manufactured by Rhodia)
Silane coupling agent: Si69 (bis(3-triethoxysilylpropyl) tetrasulfide; manufactured by Evonik Degussa)
Stearic acid: Stearic acid YR (manufactured by NOF Corporation)
Terpene resin: YS RESIN TO-125 (manufactured by Yasuhara Chemical Co., Ltd.)
Oil: Extract No. 4S, manufactured by Showa Shell Sekiyu K.K.
Zinc white: Zinc white #3 (manufactured by Seido Chemical Industry Co., Ltd.)
Sulfur: Oil-treated sulfur, manufactured by Karuizawa Refinery Ltd.
Vulcanization accelerator: NOCCELER CZ-G (manufactured by Ouchi Shinko Chemical Industrial Co., Ltd.)
Cyclic polysulfide: Cyclic polysulfide having R═(CH₂)₂O(CH₂)₂, x (average)=4, and n=2-3 in Formula (s)

Note that the cyclic polysulfide was synthesized as follows.

First, 1.98 g (0.02 mol) of 1,2-dichloroethane and 1197 g (2 mol) of 30% sodium polysulfide (NA₂S₄) aqueous solution were added to toluene (500 g), and then 0.64 g (0.1 mol) of tetrabutylammonium bromide was added, and reacted for 2 hours at 50° C. Subsequently, the reaction temperature was raised to 90° C., and a solution obtained by dissolving 311 g (1.8 mol) of dichloroethyl formal in 300 g of toluene was added drop-wise over the course of 1 hour, and then reacted for another 5 hours. After the reaction, the organic layer was separated and condensed under reduced pressure at 90° C., and 405 g of the above cyclic polysulfide was obtained (yield: 96.9%).

As is clear from Table 1, each of Examples 1 to 3 containing carboxynitrone-modified SBR exhibited excellent rubber hardness, wet grip performance, fuel consumption performance, storage modulus, breaking strength, and wear resistance, as compared with Comparative Example 1 which does not contain carboxynitrone-modified SBR.

The fact that the tire rubber compositions of Examples 1 to 3 exhibit excellent rubber hardness and storage modulus in this way indicates that the rubber compositions have excellent steering stability at the time of high-speed traveling when formed into a tire. Similarly, the fact that the rubber compositions exhibit excellent wear resistance and breaking strength at high temperatures indicates that the rubber compositions have excellent tire property stability when traveling at high speeds for a long period of time.

In addition, in comparison with Examples 1 and 2, it was demonstrated that the wet grip performance is particularly excellent when the composition in which the content of the carboxynitrone-modified SBR in the diene rubber is not less than 50 mass % is used (Example 2).

On the other hand, in Comparative Example 2, which does not contain carboxynitrone-modified SBR but contains diphenylnitrone-modified SBR, the wet grip performance, fuel consumption performance, breaking strength, and wear resistance were insufficient.

In addition, in Comparative Example 3, which does not contain carboxynitrone-modified SBR but contains diphenylnitrone-modified SBR, the rubber hardness, wet grip performance, fuel consumption performance, breaking strength, and wear resistance were insufficient.

### REFERENCE SIGNS LIST

1 Bead portion
2 Sidewall portion
3 Tire tread portion
4 Carcass layer
5 Bead core
6 Bead filler
7 Belt layer
8 Rim cushion

1. A rubber composition for tire treads comprising an inorganic filler containing silica and a diene rubber containing a carboxy-modified polymer, wherein
the content of the inorganic filler is from 70 to 170 parts by mass per 100 parts by mass of the diene rubber;
the content of the silica is from 70 to 160 parts by mass per 100 parts by mass of the diene rubber;
the carboxy-modified polymer is obtained by modifying a styrene-butadiene rubber (A) with a nitrone compound (B) having a carboxy group;
the content of the carboxy-modified polymer in the diene rubber is from 10 to 100 mass %;
the content of styrene units in the styrene-butadiene rubber (A) is not less than 36 mass %; and
a degree of modification of the carboxy-modified polymer is from 0.02 to 4.0 mol %; the degree of modification is defined as a proportion (mol %) of double bonds modified by the nitrone compound (B) having a carboxy group relative to all double bonds attributed to butadiene in the styrene-butadiene rubber (A).

2. The rubber composition for tire treads according to claim 1, wherein the nitrone compound having a carboxy group is a compound selected from the group consisting of N-phenyl-α-(4-carboxyphenyl)nitrone, N-phenyl-α-(3-carboxyphenyl)nitrone, N-phenyl-α-(2-carboxyphenyl)nitrone, N-(4-carboxyphenyl)-α-phenylnitrone, N-(3-carboxyphenyl)-α-phenylnitrone, and N-(2-carboxyphenyl)-α-phenylnitrone.

3. The rubber composition for tire treads according to claim 1, further comprising a cyclic polysulfide represented by the following general formula (s),
wherein the content of the cyclic polysulfide is from 0.2 to 5 parts by mass per 100 parts by mass of the diene rubber; 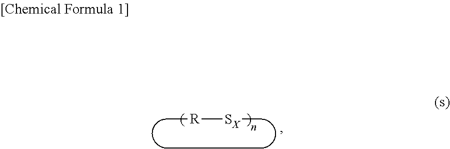
in general formula (s), R is a substituted or unsubstituted alkylene group having from 4 to 8 carbon atoms, a substituted or unsubstituted oxyalkylene group having from 4 to 8 carbon atoms (“—R₁—O—”, where R₁ is an alkylene group having from 4 to 8 carbon atoms), or —R₂—O—R₃— (where R₂ and R₃ are each independently an alkylene group having from 1 to 7 carbon atoms); here, x is 3 to 5 on the average, and n is an integer of 1 to 5.

4. The rubber composition for tire treads according to claim 1, wherein an amount of the nitrone compound (B) having a carboxy group that is used to modify the styrene-butadiene rubber (A) is from 0.1 to 10 parts by mass per 100 parts by mass of the diene rubber.

5. A pneumatic tire comprising tire treads formed using the rubber composition for tire treads described in claim 1.

6. The rubber composition for tire treads according to claim 2, further comprising a cyclic polysulfide represented by the following general formula (s),
wherein the content of the cyclic polysulfide is from 0.2 to 5 parts by mass per 100 parts by mass of the diene rubber; 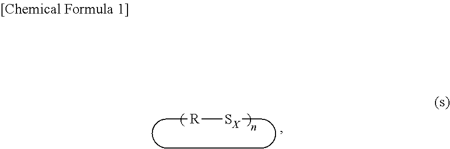
in general formula (s), R is a substituted or unsubstituted alkylene group having from 4 to 8 carbon atoms, a substituted or unsubstituted oxyalkylene group having from 4 to 8 carbon atoms (“—R₁—O—”, where R₁ is an alkylene group having from 4 to 8 carbon atoms), or —R₂—O—R₃-(where R₂ and R₃ are each independently an alkylene group having from 1 to 7 carbon atoms); here, x is 3 to 5 on the average, and n is an integer of 1 to 5.

7. The rubber composition for tire treads according to claim 2, wherein an amount of the nitrone compound (B) having a carboxy group that is used to modify the styrene-butadiene rubber (A) is from 0.1 to 10 parts by mass per 100 parts by mass of the diene rubber.

8. The rubber composition for tire treads according to claim 3, wherein an amount of the nitrone compound (B) having a carboxy group that is used to modify the styrene-butadiene rubber (A) is from 0.1 to 10 parts by mass per 100 parts by mass of the diene rubber.

9. The rubber composition for tire treads according to claim 6, wherein an amount of the nitrone compound (B) having a carboxy group that is used to modify the styrene-butadiene rubber (A) is from 0.1 to 10 parts by mass per 100 parts by mass of the diene rubber.

10. A pneumatic tire comprising tire treads formed using the rubber composition for tire treads described in claim 2.

11. A pneumatic tire comprising tire treads formed using the rubber composition for tire treads described in claim 3.

12. A pneumatic tire comprising tire treads formed using the rubber composition for tire treads described in claim 4.

13. A pneumatic tire comprising tire treads formed using the rubber composition for tire treads described in claim 6.

14. A pneumatic tire comprising tire treads formed using the rubber composition for tire treads described in claim 7.

15. A pneumatic tire comprising tire treads formed using the rubber composition for tire treads described in claim 8.

16. A pneumatic tire comprising tire treads formed using the rubber composition for tire treads described in claim 9.
